(19) United States
(12) Patent Application Publication
(10) Pub. No.: US 2015/0187327 A1
(43) Pub. Date: Jul. 2, 2015

(54) WEARABLE ELECTRONIC DEVICE WITH COLOR DISPLAY

(71) Applicants: Mark Francis, Portland, OR (US); Gregory Peek, Northplains, OR (US); Jerry Bautista, Castro Valley, CA (US); Mark Pontarelli, Lake Oswego, OR (US)

(72) Inventors: Mark Francis, Portland, OR (US); Gregory Peek, Northplains, OR (US); Jerry Bautista, Castro Valley, CA (US); Mark Pontarelli, Lake Oswego, OR (US)

(21) Appl. No.: 14/142,796

(22) Filed: Dec. 28, 2013

(51) Int. Cl. G09G 5/02; G06F 3/01

(52) U.S. Cl. CPC G09G 5/02; G06F 3/014

(57) ABSTRACT

A wearable electronic device is described herein. The wearable electronic device includes a housing for the wearable electronic device. A display is supported by the housing. The wearable electronic device also includes a colorimeter comprising a sensor to sense a first color. The colorimeter is to display on the display a second color corresponding to the sensed first color.

### TECHNICAL FIELD

The present techniques relate generally to electronic devices within wearable form factors. More specifically, the present techniques relate generally to a colorimeter that provides real-time customization of the appearance of a wearable device, as well as a marketplace for designs for the wearable smart device.

### BACKGROUND ART

Wearable electronic devices include smart watches, fitness trackers, connected glasses, activity trackers, and the like. Frequently, wearable electronic devices are unisex in design. Additionally, wearable electronic devices are often used by pairing the wearable electronic device to another electronic device, such as a smart phone, tablet computer, or other mobile device. In this manner, wearable electronic devices are typically unable to operate without being tethered to a primary device.

### BRIEF DESCRIPTION OF THE DRAWINGS

FIG. 1 is a block diagram of an electronic device that may be a wearable device that includes a colorimeter;

FIG. 2 is an illustration of a plurality of devices connected via a web portal;

FIG. 3 is an illustration of a stand-alone smart bracelet that may house the electronic device; and

FIG. 4 is a process flow diagram of a method for providing customization of the appearance of a wearable device.

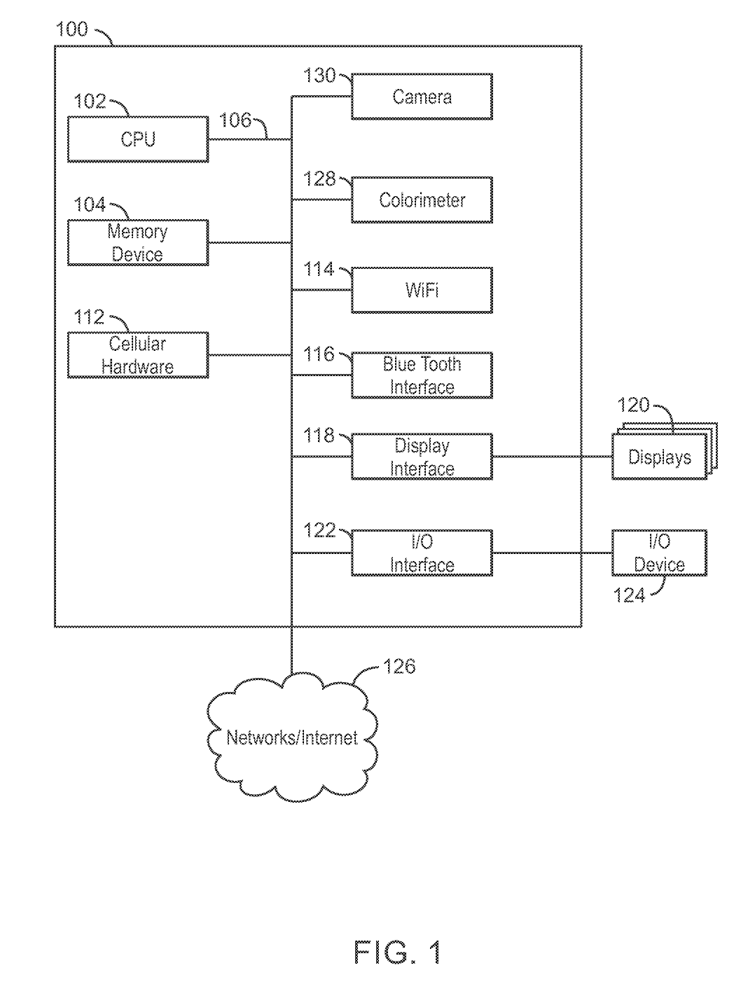

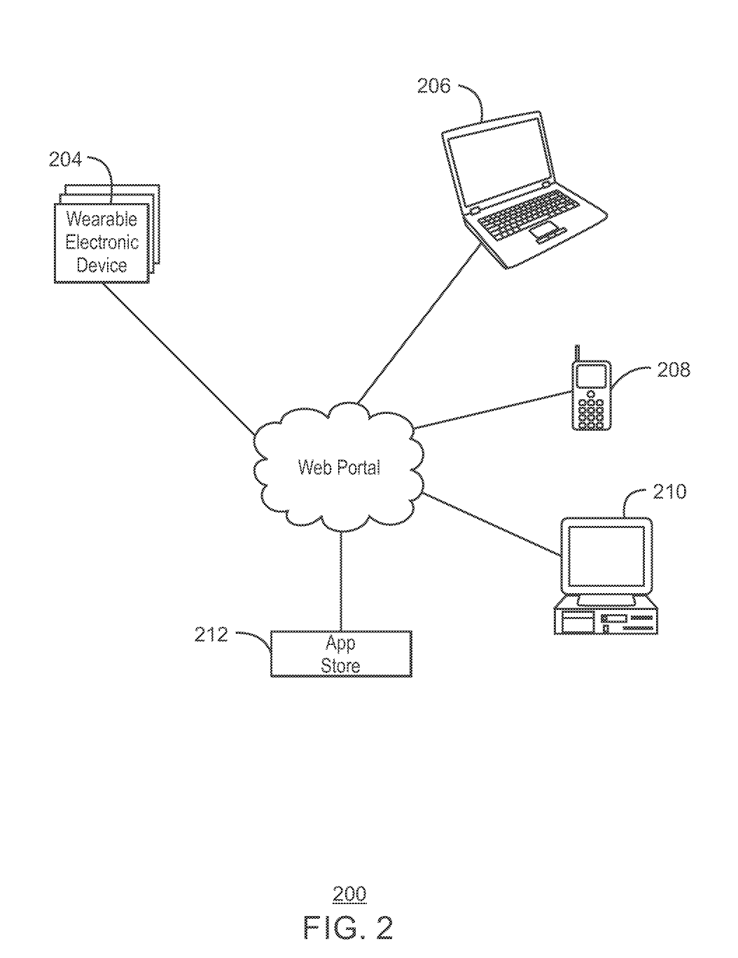

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, the vast majority of wearable electronic devices are unisex. This results in a product that can be unappealing to women that desire a decidedly fashionable product with an eye-appealing form factor. As current wearable electronic devices products come in the form factors of watches, ear pierces, glasses, or activity bands, these form factors may be too large or ill suited for use by an average female. Furthermore, current wearable electronic devices are not stand alone products. Rather, these devices are paired with a primary device in order to retrieve data.

Typical wearable smart devices are restricted to a single color. For example, the device may always be black and without the ability to match colors of what the user is wearing. Most often, any design appearing on the wearable device is static.

Embodiments described herein generally relate to a colorimeter that provides real-time customization of the appearance of a wearable device, as well as a marketplace for designs for the wearable smart device. In embodiments, a colorimeter is hidden beneath the dead-front screen of the bracelet. The user activates the colorimeter to capture an image and make this color, pattern, and/or design used on the top display of the bracelet. The color, pattern, etc. is also saved and can be used at other times. In embodiments, the pattern can also be made available through an application (app) store to other product users. The stand-alone smart bracelet also includes at least one networking functionality.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device 100 that may be a wearable device that includes a colorimeter. In some cases, the wearable device is a stand-alone bracelet with a double contour. As used herein, the term “stand-alone” may refer to the ability of the device to transmit data across a network without being tethered to another, primary device. Additionally, the term “stand-alone” may refer to the ability of the device to transmit data across a plurality of networks without being tethered to a primary device. The electronic device 100 may be enclosed within any wearable form factor. In some cases, the electronic device 100 is enclosed within a wearable form factor. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102.

The memory device 104 can include random access memory (RAM), read only memory (ROM), flash memory, or any other suitable memory systems. For example, the memory device 104 may include dynamic random access memory (DRAM). In some cases, the electronic device 100 includes an image capture mechanism, such as a camera 130. The CPU 102 may be linked through the bus 106 to cellular hardware 112. The cellular hardware 112 may be any cellular technology, for example, the 4G standard (International Mobile Telecommunications-Advanced (IMT-Advanced) Standard promulgated by the International Telecommunications Union-Radio communication Sector (ITU-R)). In this manner, the electronic device 100 may access any network 126 without being tethered or paired to another device, where the network 126 is a cellular network. Thus, the electronic device is a stand-alone device that may be enclosed within a wearable form factor.

The CPU 102 may also be linked through the bus 106 to WiFi hardware 114. The WiFi hardware is hardware according to WiFi standards (standards promulgated as Institute of Electrical and Electronics Engineers' (IEEE) 802.11 standards). The WiFi hardware enables the electronic device 100 to connect to the Internet using the Transmission Control Protocol and the Internet Protocol (TCP/IP), where the network 126 is the Internet. Accordingly, the device 100 can enable end-to-end connectivity with the Internet by addressing, routing, transmitting, and receiving data according to the TCP/IP protocol without the use of another device. Additionally, Bluetooth Interface 116 may be coupled to the CPU 102 through the bus 106. The Bluetooth Interface 116 is an interface according to Bluetooth networks (based on the Bluetooth standard promulgated by the Bluetooth Special Interest Group). The Bluetooth Interface 116 enables the electronic device 100 to be paired with other Bluetooth enabled devices through a personal area network (PAN). Accordingly, the network 126 may be a PAN. Examples of Bluetooth enabled devices include a laptop computer, desktop computer, ultrabook, tablet computer, mobile device, or server, among others.

In some cases the cellular hardware 112, the WiFi hardware 114, and the Bluetooth Interface 116 are implemented through various radios. Accordingly, the electronic device 100 may include one or more radios capable of transmitting and receiving signals using various suitable wireless communications techniques. Such techniques may involve communications across one or more wireless networks 126. Exemplary wireless networks include wireless local area networks (WLANs), wireless personal area networks (WPANs), wireless metropolitan area network (WMANs), cellular networks, satellite networks, or the like. In communicating across such networks, the radios may operate in accordance with one or more applicable standards in any version. In embodiments, the electronic device 100 may dynamically select a network to transmit data based on accessibility and battery power remaining. For example, if the cellular hardware 112 has low accessibility due to low signal strength of a received radio signal, the electronic device may select another networking functionality based on the lack of accessibility for the cellular hardware. Similarly, if the electronic device is low on battery power, the device can dynamically select a networking functionality that uses the least amount of power. In this manner, the electronic device can intelligently select a networking functionality.

The CPU 102 may be linked through the bus 106 to a display interface 118 configured to connect the electronic device 100 to a plurality of displays 120. The displays 120 may include a display screen that is a built-in component of the electronic device 100. In some cases, the display device 120 may also include a computer monitor, television, or projector, among others, that is externally connected to the electronic device 100. The CPU 102 may also be connected through the bus 106 to an input/output (I/O) device interface 122 configured to connect the electronic device 100 to one or more I/O devices 124. The I/O devices 124 may include, for example, a pointing device or a touch screen, among others. The I/O devices 120 may be built-in components of the electronic device 100.

The electronic device 100 may also include a colorimeter 128 and an image capture mechanism or camera 130. The colorimeter 128 may be any device used to capture color data and cause a matching color to be rendered on the display 120. In some cases, a transformation scheme is applied to the color data captured by the colorimeter. The transformation scheme and convert captured color data to a particular color perceived by human eyes. The transformation scheme may also be used to calibrate the colorimeter so that the captured color data aligns more closely with color perceived by human eyes when viewing the color data. In some cases, the transformation scheme is able to detect a sheen element of the color data, or a lighting aspect that changes the color data. The camera 130 may be used to capture a pattern or design to be rendered on the displays 120. The captured color by the colorimeter, or the patter or display captured by the camera 130 may be saved in a memory 104 of the electronic device 100. In some embodiments, the camera 130 or the colorimeter 128 includes local memory used to store respective captured patterns, designs, or colors.

The electronic device 100 may include a plurality of applications (apps) that can be downloaded using the network 126. The apps can be used to customize the device. For example, a user can download apps so that certain types of data and notifications can be accessed by the electronic device 100. In some cases, a user access apps through a web portal. In some embodiments, designs and patterns created by the colorimeter 128 may be uploaded to an app store using the network. Other users of the wearable electronic device can then download designs and patterns that have been uploaded to the app store to their respective devices. Thus, the app store or web portal can be a marketplace for designs of a wearable smart device.

The block diagram of FIG. 1 is not intended to indicate that the electronic device 100 is to include all of the components shown in FIG. 1. Further, the electronic device 100 may include any number of additional components not shown in FIG. 1, depending on the details of the specific implementation.

FIG. 2 is an illustration of a plurality of devices connected via a web portal 202. In some cases, the web portal 202 is a website accessible via a network, such as the network 126 (FIG. 1). Additionally, the web portal 202 may be a social networking site. In some examples, a user of the wearable electronic device 204 can share a “color of the day’ from the wearable electronic device 204. Moreover, the web portal 202 can include gaming, business websites, news websites, file-sharing websites, web based email websites, or any combination thereof. In some cases, the web portal 202 employs a subscription based service so that users may access the content of the web portal 202. The web portal 202 may also authenticate the wearable electronic devices 204. A user can access content of the web portal via a wearable electronic device 204.

In some cases, secondary electronic device, such as a laptop 206, a mobile device 208, or a desktop 210 may access the web portal 202. A user may access the secondary electronic device to browse the web portal 202 to configure the types of real-time notifications, such as a number data and alerts that will be passed to a corresponding wearable electronic device 204. Instructions from the web portal 202 may be pushed to the corresponding wearable electronic device 204. The web portal 202 can then configure the notifications that will be pushed to the corresponding wearable electronic device 204. The corresponding wearable electronic device 204 can also be configured to pull notifications from the web portal 202 at regular intervals or time periods.

An app store 212 may be coupled with the web portal 202. The app store 212 may include a plurality of applications that can be applied to a profile of the wearable electronic device 204 on the web portal 202. In this manner, various apps can be added to provide desired functionality to the wearable electronic device 204. In some examples, various colors and patterns can be added from the app store 212 to a profile of the wearable electronic device 204 on the web portal 202.

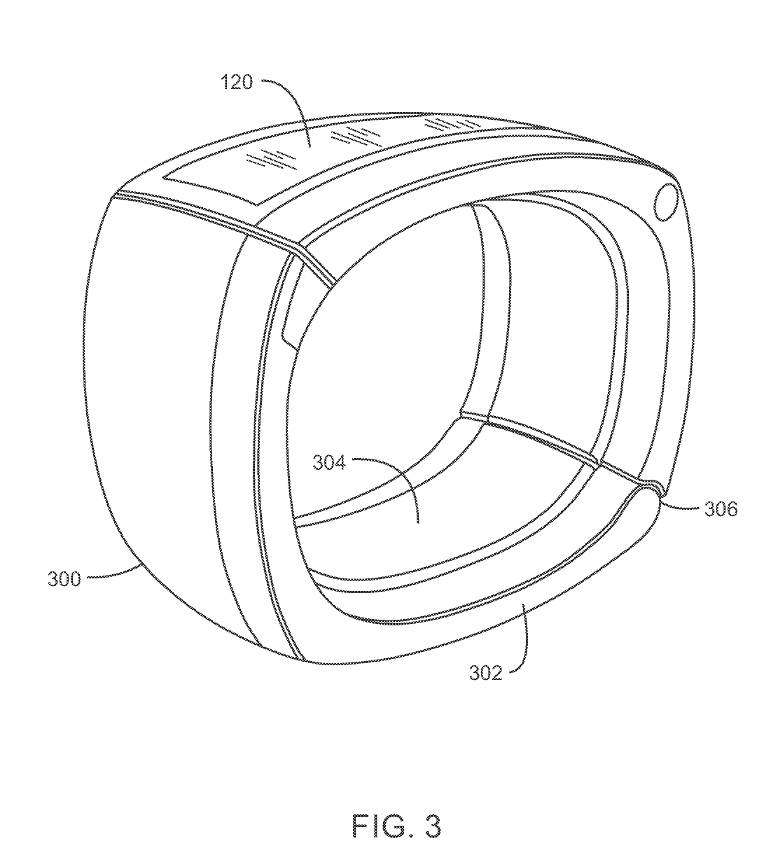

FIG. 3 is an illustration of a stand-alone smart bracelet 300 that may house the electronic device 100. A display device 120 is illustrated on the stand-alone smart bracelet 300. One display is illustrated for ease of description. However, the bracelet 300 may include a plurality of displays. The display may be a light-emitting diode (LED), organic light-emitting diode (OLED), flexible OLED, thin-film-transistor liquid-crystal display (TFT LCD), electronic paper, or any other flexible, thin display technology. The display 120 is illustrated using a dashed line to indicate that display 120 is below the surface of the housing 200. The housing 200 may be a single molded housing that contains the display 120 within the housing. In some cases, an outer cover may be used to cover the display 120, and the outer cover can be joined with another piece to form the housing 200.

The smart bracelet 300 includes a colorimeter as discussed above. The colorimeter may be coupled with a CPU that processes color data gathered by the colorimeter. The colorimeter may be mounted within the smart bracelet 300 and used to measure the spectral content of light so that the display can then be calibrated to the measured light value. In some cases, the colorimeter is a tristimulus colorimeter that measures the tristimulus values of a color. Color profiles may be created, and the CPU can process and render the color profiles on display 120. In embodiments, the colorimeter may generate three color data points from the wavelengths of a measured color. The three data points represent a reflectance of the measured color value, and the CPU may analyze these data points and calibrate the display 120 to match the three data points.

In embodiments, the display 120 include a plurality of mini-vias. The mini-vias may be used to change the color of a “dead screen” of the bracelet. As used herein, a dead screen refers to the display when it is not in use and is to be blank. Typically, a dead screen is black in color, and blends seamlessly with a black wearable form factor. Mini-vias may enable the display to have a dead screen that is any color when it is calibrated with data from the colorimeter. In this manner, the dead screen can be adjusted to blend in with any color form factor, creating a smooth, uniform, visually uninterrupted wearable form factor surface.

The display 120 may be disposed underneath a surface of the housing 300. In this manner, a surface of the housing 300 will be a continuous, smooth material located atop of the display 120. The surface of the housing 300 may be curved or contoured along several axes.

In some cases, the stand-alone smart bracelet 300 may be coupled with an accent piece 302. The accent piece 302 can add a visual interest and distinction to the appearance of the bracelet 300. Additionally, the bracelet 300 may be coupled with an insert piece 304. The insert piece 304 may be of different sizes and textures. When the insert piece 304 is thicker, the inner diameter of the bracelet 300 is decreased. This decrease in inner diameter enables the bracelet 300 to fit smaller wrist sizes. Accordingly, the insert piece 304 enables the bracelet 300 to be adjustable in size.

A hinge may be located at reference number 306. The bracelet 300 may open and close using the hinge 306. The hinge 306 rotatably couples portions of the bracelet 300 together. The hinge is located in both the bracelet 300 and the accent piece 302. A clasp may be used in combination with the hinge 306 to secure portions of the bracelet 300. The clasp may be secured using magnets located within the bracelet 300. The bracelet 300 may also include sensors to detect when the bracelet 300 is opened or closed.

In some cases, the smart bracelet 300 is a designed specifically for women. The bracelet design incorporates fashion elements, and the materials, colors, textures, size and weight of the bracelet are purposefully designed to hide the technology. Moreover, the bracelet is designed to be attractive to wear even when the technology features are not desired. Accordingly, the colorimeter can be used to match and coordinate with any color desired. For example, the colorimeter may collect color data to calibrate the displays of the wearable form factor to match the clothing and accessories of the user. The smart bracelet may also be customized with patterns and other design elements that are captured by the colorimeter and rendered on the displays of the wearable device. Further, the bracelet is a fashionable, wearable product that can operate independently from a smart phone or mobile device. Accordingly, the smart bracelet can be a beautiful cuff bracelet that is always connected, cellular based and, has been designed to blend in with any outfit and other accessory that a woman would wear. Moreover, a smart phone is not the compute and connectivity center for the bracelet, as the bracelet is a fashion-first design that is not tethered to a smart phone. With the cellular connectivity, it is an independent compute product.

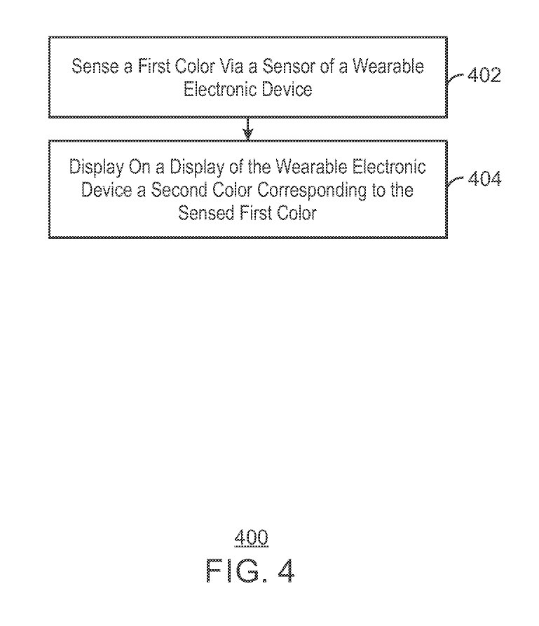

FIG. 4 is a process flow diagram of a method 400 for providing customization of the appearance of a wearable device. The wearable device may be a double contour smart bracelet. In embodiments, the customization may take place in real time as the electronic device senses colors in its environment and responds as described herein.

At block 402, a first color is sensed via a sensor of the wearable electronic device. As explained herein, the sensor may be part of a colorimeter. Additionally, a camera may be used to gather pattern information. The wearable electronic device typically may include a housing and a display associated with the housing. At block 404, the wearable electronic device displays on its display a second color corresponding to the sensed first color. The second color may be chosen to match the first color, or alternatively, to compliment the first color. Similarly, designs or patterns may be included in the display. In some cases, the matching color or design may be uploaded to an application store, web portable, marketplace, or any combination thereof.

The wearable electronic device described herein may provide a stylish, fashionable design with a size appropriate for female consumers. Moreover, the bracelet enables greater use due to being a standalone device. The wearable electronic device enables a consumer to stay connected in a more natural manner than using her phone and/or without her phone necessarily present.

### Example 1

A wearable electronic device is described herein. The wearable electronic device includes a housing for the wearable electronic device. A display is supported by the housing. The wearable electronic device also includes a colorimeter comprising a sensor to sense a first color. The colorimeter is to display on the display a second color corresponding to the sensed first color.

The second color may be to match the sensed first color. The colorimeter may fill the display with the second color. The colorimeter may comprise a spectral colorimeter or a tristimulus colorimeter. The wearable electronic device may include a processor to execute instructions to process data corresponding to the sensed first color to generate the second color. The colorimeter may include a memory to store color data. The wearable electronic device may comprise an image capture device. The image capture device may capture an image having a first pattern, and the colorimeter may display on the display a second pattern corresponding to the first pattern of the captured image. The second pattern may match the first pattern. The colorimeter may fill the display with the second pattern. The wearable electronic device may comprise a wireless transceiver, and the wearable electronic device wherein the electronic device may upload the first pattern and/or the second pattern to an application (app) store via the wireless transceiver. The display of the wearable electronic device may be coupled with a plurality of mini-vias to change the color of a dead screen of the display. The wearable electronic device may be a double contour bracelet. The wearable electronic device may include an accent piece to coordinate with the second color.

### Example 2

A method for providing customization of the appearance of a wearable electronic device is described herein. The method includes sensing a first color using a sensor of the wearable electronic device. The method also includes displaying on a display of the wearable electronic device a second color corresponding to the sensed first color.

The method may include matching the second color to the sensed first color. The method may include filling the display with the second color. The method may include executing instructions to process data corresponding to the sensed first color to generate the second color. The method may include capturing an image having a first pattern and displaying on the display a second pattern corresponding to the first pattern of the captured image. The second pattern may match the first pattern. The method may include filling the display with the second pattern.

### Example 3

A wearable electronic device is described herein. The wearable electronic device includes a housing. A display supported by the housing. An image capture device may capture an image having a first pattern. A colorimeter communicatively coupled the display may display on the display a second pattern corresponding to the first pattern of the captured image. The wearable electronic device may include a transceiver and a memory that is to store instructions. A processor communicatively coupled to the transceiver and the memory may execute the instructions to upload the first pattern and/or the second pattern to an application (app) store via the transceiver.

The second pattern may match the first pattern. The colorimeter may fill the display with the second pattern.

It is to be understood that specifics in the aforementioned examples may be used anywhere in one or more embodiments. For instance, all optional features of the electronic device described above may also be implemented with respect to either of the methods or the computer-readable medium described herein. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A wearable electronic device, comprising:
a housing for the wearable electronic device;
a display supported by the housing; and
a colorimeter comprising a sensor to sense a first color, the colorimeter is to display on the display a second color corresponding to the sensed first color.

2. The wearable electronic device of claim 1, wherein the second color is to match the sensed first color.

3. The wearable electronic device of claim 1, wherein the colorimeter is to fill the display with the second color.

4. The wearable electronic device of claim 1, wherein the colorimeter comprises a spectral colorimeter.

5. The wearable electronic device of claim 1, wherein the colorimeter comprises a tristimulus colorimeter.

6. The wearable electronic device of claim 1, comprising a processor to execute instructions to process data corresponding to the sensed first color to generate the second color.

7. The wearable electronic device of claim 1, wherein the colorimeter includes a memory to store color data.

8. The wearable electronic device of claim 1, comprising an image capture device.

9. The wearable electronic device of claim 8, wherein the image capture device is to capture an image having a first pattern, and the colorimeter is to display on the display a second pattern corresponding to the first pattern of the captured image.

10. The wearable electronic device of claim 9, wherein the second pattern is to match the first pattern.

11. The wearable electronic device of claim 9, wherein the colorimeter is to fill the display with the second pattern.

12. The wearable electronic device of claim 1, comprising a wireless transceiver, wherein the electronic device is to upload the first pattern and/or the second pattern to an application (app) store via the wireless transceiver.

13. The wearable electronic device of claim 1, wherein the display is coupled with a plurality of mini-vias to change the color of a dead screen of the display.

14. The wearable electronic device of claim 1, wherein the wearable electronic device is a double contour bracelet.

15. The wearable electronic device of claim 1, comprising an accent piece to coordinate with the second color.

16. A method for providing customization of the appearance of a wearable electronic device, comprising:
sensing a first color using a sensor of the wearable electronic device; and
displaying on a display of the wearable electronic device a second color corresponding to the sensed first color.

17. The method of claim 16, comprising matching the second color to the sensed first color.

18. The method of claim 16, comprising filling the display with the second color.

19. The method of claim 16, comprising executing instructions to process data corresponding to the sensed first color to generate the second color.

20. The method of claim 16, comprising:
capturing an image having a first pattern; and
displaying on the display a second pattern corresponding to the first pattern of the captured image.

21. The method of claim 20, wherein the second pattern is to match the first pattern.

22. The method of claim 20, comprising filling the display with the second pattern.

23. A wearable electronic device, comprising:
a housing;
a display supported by the housing;
an image capture device is to capture an image having a first pattern,
a colorimeter communicatively coupled the display is to display on the display a second pattern corresponding to the first pattern of the captured image;
a transceiver;
a memory that is to store instructions; and
a processor communicatively coupled to the transceiver and the memory, wherein when the processor is to execute the instructions, the processor is to upload the first pattern and/or the second pattern to an application (app) store via the transceiver.

24. The wearable electronic device of claim 23, wherein the second pattern is to match the first pattern.

25. The wearable electronic device of claim 23, wherein the colorimeter is to fill the display with the second pattern.
